(19) United States
(12) Patent Application Publication
(10) Pub. No.: US 2026/0113702 A1
(43) Pub. Date: Apr. 23, 2026

(54) DETECTION LOGIC IN GATEWAY DEVICES TO ENTER LOW POWER MODE

(71) Applicant: QUALCOMM Incorporated, San Diego, CA (US)

(72) Inventors: Abhishek RASTOGI, Bangalore (IN); Nanda KRISHNAN, Reddiyar Palyam (IN); Kiran Kumar C.S.K, Bangalore (IN); Sourav PODDAR, Bangalore (IN)

(21) Appl. No.: 18/919,230

(22) Filed: Oct. 17, 2024

(51) Int. Cl. H04W 52/02; H04L 43/0811; H04W 84/12

(52) U.S. Cl. CPC H04W 52/0203; H04L 43/0811; H04W 84/12

(57) ABSTRACT

Certain aspects of the present disclosure provide a method at a network node. The network node may determine that a networking subsystem (NSS) and a wireless fidelity (WI-FI) subsystem associated with the network node are in an idle state. The network node may transition from an active mode into a low power mode, based on the NSS and/or the WI-FI subsystem being in the idle state.

### BACKGROUND

### Field of the Disclosure

Aspects of the present disclosure relate to techniques for managing power modes of a network node such as a gateway device.

### Description of Related Art

A network node may take the form of a gateway device, a router device, a switch, a server, or any other device/software to perform multiple functions. In one example, the network node may act as a gate between two different networks. In another example, the network node may enable traffic flow in or out of a network. In another example, the network node may enable data to flow from one network to another network. In another example, the network node may connect disparate networks by translating communications from one protocol to another.

The network node consumes power during processing of data. However, in some cases, despite any data getting processed by the network node, power consumption may continue to happen as there may be radio waves continuously emitted through wireless interfaces of the network node. Accordingly, there is a need to reduce the power consumption of the network node when the network node is not in use.

### SUMMARY

One aspect provides a method at a network node. The method may include determining at least one subsystem associated with the network node is in an idle state. The method may further include transitioning the network node from an active mode into a low power mode, based on the at least one subsystem in the idle state.

Other aspects provide: an apparatus operable, configured, or otherwise adapted to perform the aforementioned method as well as those described elsewhere herein; a non-transitory, computer-readable media comprising instructions that, when executed by one or more processor of an apparatus, cause the apparatus to perform the aforementioned method as well as those described elsewhere herein; a computer program product embodied on a computer-readable storage medium comprising code for performing the aforementioned method as well as those described elsewhere herein; and an apparatus comprising means for performing the aforementioned method as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example system for managing power modes of a network node, in accordance with certain aspects of the present disclosure.

FIG. 2 depicts example modules of a system for managing power modes of a network node, in accordance with certain aspects of the present disclosure.

FIG. 3 depicts a flow diagram for determining whether a networking subsystem (NSS) associated with a network node is in an idle state, in accordance with certain aspects of the present disclosure.

FIG. 4 depicts a flow diagram for determining whether a wireless fidelity (WI-FI) subsystem associated with a network node is in an idle state, in accordance with certain aspects of the present disclosure.

FIG. 5 depicts a method at a network node for managing power modes of the network node, in accordance with certain aspects of the present disclosure.

### DETAILED DESCRIPTION

Aspects of the present disclosure relate to techniques for managing power modes of a network node (e.g., such as a gateway device, a router device). In one example, the network node may be used to access wireless network on user equipments (UEs). In another example, the network node may include and execute one or more software applications (e.g., to transfer data traffic information associated with the network node to a server device).

As discussed above, power consumption of the network node may continue to happen, despite any data getting processed by the network node, as there may be radio waves continuously emitted through wireless interfaces of the network node. So, there is a need to reduce the power consumption of the network node when the network node is not in use (e.g., by switching from an active mode of the network node to a low power mode of the network node). Also, the switch to the low power mode has to be implemented with minimal user intervention. Accordingly, there is a need for a mechanism to automatically detect (auto-detect) an idle state of the network node and then activate the low power mode of the network node.

Techniques described herein provide a one-time configurable intelligent logic at an application layer of the network node to auto-detect the idle state of all subsystems associated with the network node and then put the network node into the low power mode to conserve power of the network node. The subsystems may include a networking subsystem (NSS) (e.g., ethernet devices and interfaces) and a wireless fidelity (WI-FI) subsystem (e.g., WI-FI access point devices and interfaces).

To detect the idle state of the subsystems associated with the network node, the application layer of the network node may periodically determine and parse multiple statistics corresponding to the subsystems such as: receive and transmit traffic statistics for both WI-FI and ethernet interfaces of the network node, linux netfilter connection track (CT) table statistics, and/or processor utilization statistics corresponding to one or more processor cores of the network node.

For example, the WI-FI subsystem may periodically collect and send the statistics such as transmit and receive data rates for the WI-FI interfaces, packet per second transmit/receive information for the WI-FI interfaces, and/or client device connection details of the WI-FI interfaces to the application layer of the network node. The NSS may periodically collect and send statistics such as transmit and receive data rates for the ethernet interfaces, packet per second transmit/receive for the ethernet interfaces, information corresponding to linux netfilter CT tables, and/or per core processor utilization to the application layer of the network node.

The application layer of the network node may process and analyze all the information/statistics received from the WI-FI subsystem and the NSS. Based on the processing of the received information/statistics, when both the NSS and the WI-FI subsystem are determined to be in the idle state (e.g., at least for a certain time period), the network node may enter the low power mode. For example, one or more components associated with the network node may be shut down for the low power mode.

Particular aspects of the subject matter described in this disclosure can be implemented to realize one or more of the following potential advantages. In some examples, the described techniques may reduce the power consumption of the network node during at least an idle period of the network node, which may allow a system including the network node to become more energy efficient.

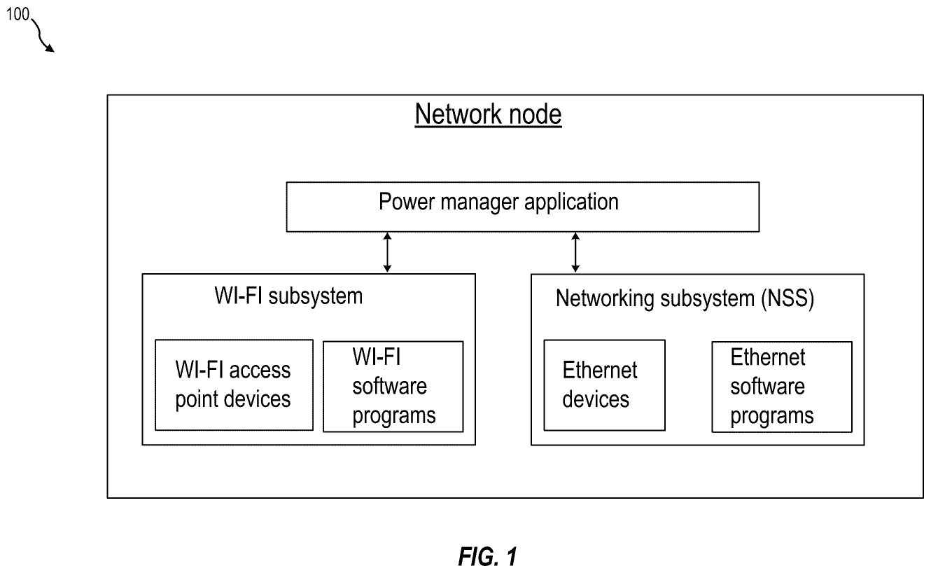

The techniques proposed herein for managing the power modes of the network node may be further understood with reference to FIG. 1-F IG. 5.

FIG. 1 depicts an example system 100 for managing power modes of a network node. In one example, the network node may correspond to a gateway device or is associated with the gateway device. In another example, the network node may correspond to a router device or is associated with the router device.

The network node may include a NSS. The NSS may include ethernet devices and ethernet software programs operating or controlling the ethernet devices. The ethernet devices may include ethernet interfaces and ports.

The network node may include a WI-FI subsystem. The WI-FI subsystem may include WI-FI access point devices and WI-FI software programs operating or controlling the WI-FI access point devices. The WI-FI access point devices may include WI-FI access point interfaces and ports.

The network node may include processors, memories, switches, and/or a power manager application. The power manager application may be a software program, which may manage the power modes of the network node. The power manager application may be at an application layer of the network node.

The power manager application may be associated with the NSS, the WI-FI subsystem, and other components of the network node. For example, the power manager application may transmit data (e.g., instructions, requests) to and/or receive data from the NSS and the WI-FI subsystem. In one example, the power manager application may send a request to the NSS and the WI-FI subsystem to periodically collect and transmit (e.g., every five seconds) NSS data and WI-FI subsystem data. The NSS data may include information/statistics associated with operations at the NSS (e.g., the ethernet devices). The WI-FI subsystem data may include information/statistics associated with operations at the WI-FI subsystem (e.g., the WI-FI access point devices).

The power manager application may periodically receive (e.g., every five seconds) the NSS data from the NSS and the WI-FI subsystem data from the WI-FI subsystem. The power manager application may process and/or store the NSS data and the WI-FI subsystem data.

Based on the processing of the NSS data, the power manager application may determine whether the NSS is in an idle state. For example, the power manager application may process the NSS data received from the NSS for a certain time period (e.g., an idle poll time period of ten minutes) to decide the NSS is in the idle state or not.

Similarly, based on the processing of the WI-FI subsystem data, the power manager application may determine whether the WI-FI subsystem is in the idle state. For example, the power manager application may process the WI-FI subsystem data received from the WI-FI subsystem for a certain time period (e.g., the idle poll time period of ten minutes) to decide the WI-FI subsystem is in the idle state or not.

When the power manager application concludes both the NSS and the WI-FI subsystem are in the idle state based on the processing of their data for the certain time period, the power manager application may enable a low power mode of the network node. For example, the power manager application may shut down one or more components of the network node for the low power mode.

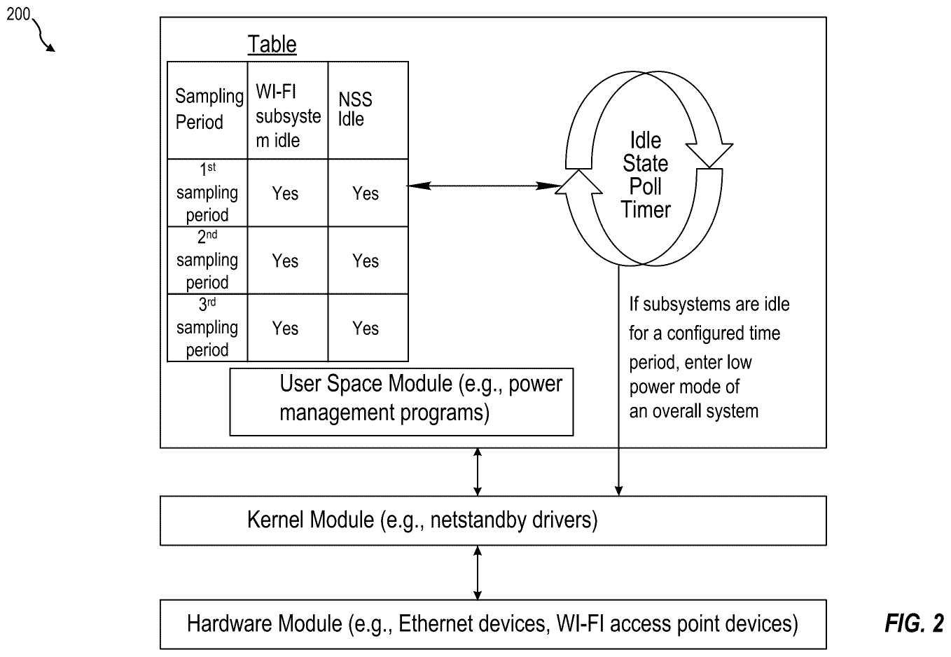

FIG. 2 depicts a diagram 200 showing multiple modules of a system (e.g., the system 100 of FIG. 1) for managing power modes of a network node. A power manager application may include or is associated with one or more modules.

The multiple modules include a user space module, a kernel module, and a hardware module. The multiple modules may be associated with each other. For example, one module may receive data (e.g., instructions, requests) from and/or transmit data to another module.

The hardware module may include one or more hardware components of the network node. The hardware components may include, but not limited to, WI-FI access point devices, ethernet devices, switches, a board support package, chips, ports and/or a packet process engine.

The kernel module may include power management drivers (e.g., ‘netstandby’ drivers) that work with the power manager application in user space and a telemetry agent device.

The kernel module (e.g., may be via the netstandby drivers) may periodically determine (or obtain) NSS data associated with the ethernet devices (e.g., after every NSS sampling period of five seconds) and may then process the NSS data. The NSS data may include processor utilization, ethernet link up events, CTs information and/or throughput of each ethernet device (port).

The kernel module (e.g., may be via the telemetry agent device) may periodically determine (or obtain) WI-FI subsystem data associated with the WI-FI access point devices (e.g., after every WI-FI subsystem sampling period of five seconds) and may then process the WI-FI subsystem data. The WI-FI subsystem data may include WI-FI statistics/traffic information (e.g., at a radio level).

The kernel module may periodically transmit the NSS data and the WI-FI subsystem data (e.g., after every five seconds) to the user space module. In one example, the kernel module may simply transmit the NSS data and the WI-FI subsystem data (e.g., without including any results of data processing that may be performed at the kernel module) to the user space module. In another example, the kernel module may transmit the NSS data and the WI-FI subsystem data (e.g., along with results of the data processing that may be performed at the kernel module) to the user space module. The results of the data processing may indicate a state (e.g., an idle state or a non-idle state) of the NSS and the WI-FI subsystem for each sampling period.

The user space module (e.g., power management programs) may execute on one or more processors. The user space module may be part of or is associated with the power manager application. The user space module may include or is associated with an energy related products (ErP) service application. The ErP service application may be same as, part of, or different from the power manager application.

The ErP service application may configure the NSS sampling period for the NSS and the WI-FI subsystem sampling period for the WI-FI subsystem. For example, the ErP service application may configure a same sampling period (e.g., five seconds) for both the NSS and the WI-FI subsystem. The ErP service application may also configure an idle state poll timer with an idle poll time period (e.g., ten minutes).

The NSS may send the NSS data and the WI-FI subsystem may send the WI-FI subsystem data, based on their configured sampling period value, to the ErP service application (e.g., directly or maybe via the kernel module).

The ErP service application may process the NSS data and the WI-FI subsystem data for each sampling period to determine the NSS and the WI-FI subsystem are in the idle state or not. For example, the ErP service application may decide: the NSS is in the idle state based on processing of the NSS data for a first sampling period and the WI-FI subsystem is also in the idle state based on processing of the WI-FI subsystem data for the first sampling period. In another example, the ErP server application may decide: the NSS is in the idle state based on processing of the NSS data for a second sampling period and the WI-FI subsystem is also in the idle state based on processing of the WI-FI subsystem data for the second sampling period. The ErP service application may generate a table to store processing results (e.g., the idle state or not) for both the NSS and the WI-FI subsystem for each sampling period.

The ErP service application may check information within the table after every idle poll time period. If both the NSS and the WI-FI subsystem have been in the idle state continuously for a duration of the idle poll time period (e.g., for 120 sampling periods based on the sampling period of 5 seconds and the idle poll time period of 10 minutes), then the ErP service application may conclude that the network node is in the idle state and may enable the low power mode of the network node. Otherwise, the network node may remain in a full operational mode.

In some aspects, the idle state poll timer may detect both the NSS and the WI-FI subsystem have been in the idle state continuously for the duration of the idle poll time period, and may then invoke a standby command. The standby command may trigger both subsystems to enter a standby mode in a sequence. For example, the NSS may first enter the standby mode and then the WI-FI subsystem may enter the standby mode. If the NSS and/or the WI-FI subsystem may receive a data packet while entering the standby mode, the network node may abort the standby mode entry and revert back to a full operational mode.

### Example Determination of an Idle State of Subsystems of a Network Node

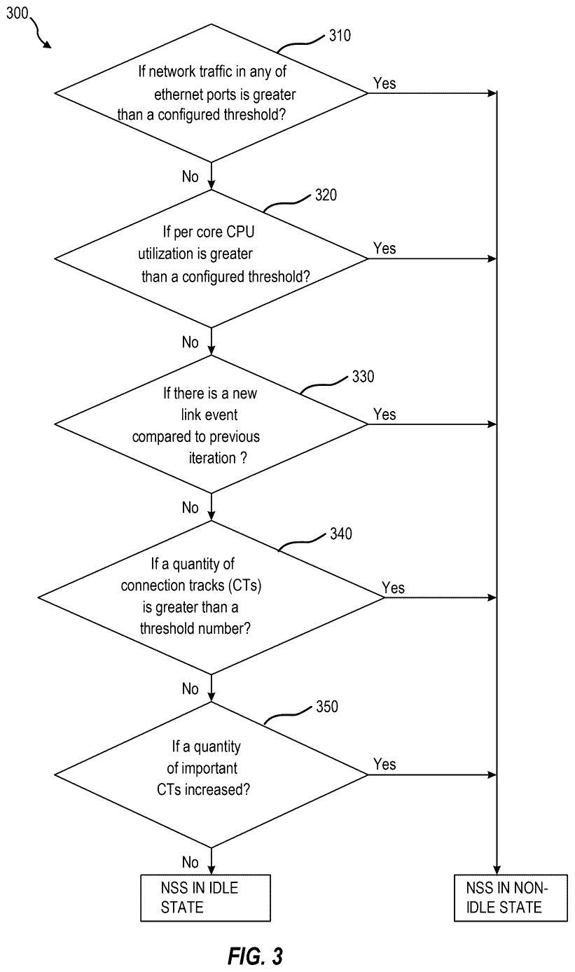

FIG. 3 depicts a flow diagram for determining whether a networking subsystem (NSS) associated with a network node is in an idle state. The NSS may include one or more ethernet devices (e.g., such as ethernet ports, ethernet interfaces) and one or more software programs operating or controlling the one or more ethernet devices.

At 310, the network node may calculate a network traffic rate (e.g., a receive traffic rate, a transmit traffic rate) at the one or more ethernet devices for a threshold time period. The threshold time period may be NSS sampling period. A value of the threshold time period may be configurable. For example, the network node may detect ongoing active network traffic for the one or more ethernet devices for the threshold time period.

In one aspect, the network node may individually calculate the network traffic rate for all ethernet devices (i.e., for each ethernet device) for the threshold time period. In another aspect, the network node may individually calculate the network traffic rate for at least some ethernet devices of the NSS for the threshold time period.

The network node may compare the network traffic rate (e.g., for any ethernet device or for each ethernet device) with a threshold traffic rate. A value of the threshold traffic rate may be configurable. The threshold traffic rate may be a receive traffic rate threshold. The threshold traffic rate may be a transmit traffic rate threshold. The threshold traffic rate may be a packet per second threshold.

When the network traffic rate (e.g., for any ethernet device or for each ethernet device) is greater than (or equal to) the threshold traffic rate, the network node may determine the NSS is in a non-idle state.

When the network traffic rate (e.g., for any ethernet device or for each ethernet device) is less the threshold traffic rate, then at 320, the network node may calculate an average utilization rate of one or more central processing units (CPUs) associated with the network node for the threshold time period. For example, the network node may compute per core CPU utilization for the threshold time period.

In one aspect, the network node may individually calculate the average utilization rate for all CPUs (i.e., for each CPU) associated with the network node for the threshold time period. In another aspect, the network node may individually calculate the average utilization rate for at least some CPUs associated with the network node for the threshold time period.

The network node may compare the average utilization rate (e.g., for any CPU or for each CPU) with a threshold utilization rate. A value of the threshold utilization rate may be configurable.

When the average utilization rate (e.g., for any CPU or for each CPU) is greater than (or equal to) the threshold utilization rate, the network node may determine the NSS is in the non-idle state.

When the average utilization rate (e.g., for any CPU or for each CPU) is less the threshold utilization rate, then at 330, the network node may detect a change in a link state of the one or more ethernet devices within the threshold time period. For example, the network node may determine whether any new link for the one or more ethernet devices came up compared to a previous sampling period (iteration).

In one aspect, the network node may individually detect the change in the link state of all ethernet devices for the threshold time period. In another aspect, the network node may individually detect the change in the link state of at least some ethernet devices for the threshold time period.

When there is any change detected in the link state (e.g., for any ethernet device or for each ethernet device) within the threshold time period, the network node may determine the NSS is in the non-idle state.

When there is no change detected in the link state (e.g., for any ethernet device or for each ethernet device) within the threshold time period, then at 340, the network node may calculate a quantity of connection tracks (CTs) in the NSS. For example, the network node may calculate a number of linux netfilter CT table flows in the NSS.

The network node may compare the quantity of CTs with a threshold number. A value of the threshold number may be configurable. When the quantity of CTs is greater than (or equal to) the threshold number, the network node may determine the NSS is in the non-idle state.

In certain aspects, some CTs (e.g., CT table flows) such as simple service discovery protocol (SSDP), domain name system (DNS), neigh discovery, all nodes address, all host address, and/or broadcast address may be considered as non-important CTs. Other CTs (e.g., the data flows in a CT table that are from or to any of the connected devices of the network node) in a linux netfilter CT table may be considered as important CTs.

When the quantity of CTs is less than the threshold number, then at 350, the network node may calculate a first quantity of CTs (e.g., which may be important CTs) for ongoing data traffic flows from one or more connected clients of the network node within a first time period. A value of the first time period may be configurable.

The network node may determine whether the first quantity of CTs is less than or equal to a second quantity of CTs (e.g., which may be important CTs) for data traffic flows from the one or more connected clients within a second time period. The first time period is after the second time period. A value of the second time period may be configurable.

The network node may determine the NSS is in the non-idle state, based on the first quantity of CTs is greater than the second quantity of CTs. For example, when a number of important CTs may be increased compared to a previous sampling period, then the NSS is determined to be in the non-idle state.

The network node may determine the NSS is in the idle state, based on the first quantity of CTs is less than or equal to the second quantity of CTs. The network node may transition from an active mode into a low power mode, when the NSS is in the idle state.

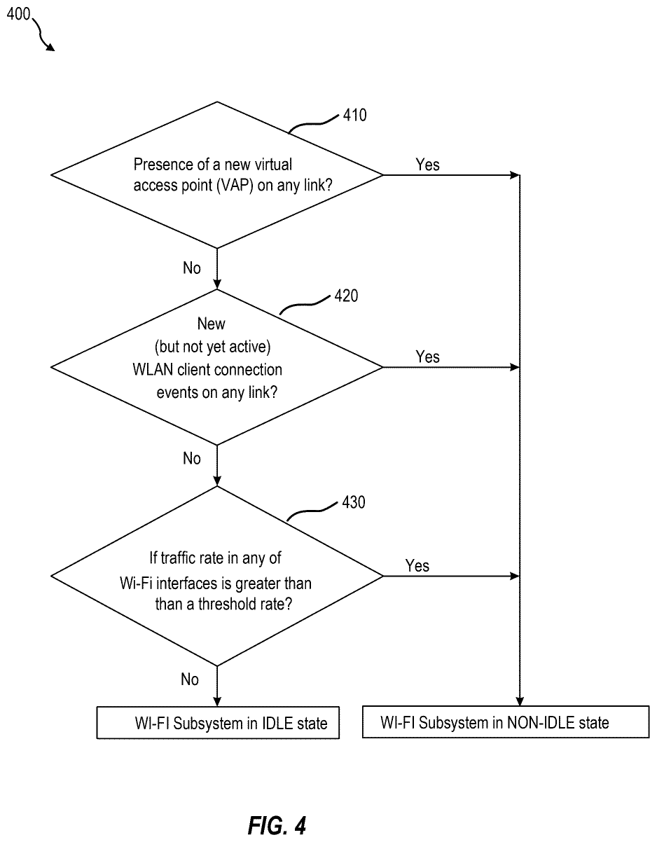

FIG. 4 depicts a flow diagram for determining whether a wireless fidelity (WI-FI) subsystem associated with a network node is in an idle state. The WI-FI subsystem may include one or more WI-FI access point devices (e.g., such as WI-FI ports, WI-FI interfaces) and one or more software programs operating or controlling the one or more WI-FI access point devices.

At 410, the network node may determine whether there is a presence of one or more new virtual access points (VAPs) on any link in the WI-FI subsystem during a threshold time period. The threshold time period may be WI-FI subsystem sampling period. A value of the threshold time period may be configurable.

When there is the presence of the new VAPs in the WI-FI subsystem during the threshold time period, the network node may determine the WI-FI subsystem is in a non-idle state.

When there is an absence of any new VAPs in the WI-FI subsystem, then at 420, the network node may determine whether there is a presence of one or more new (and maybe inactive) wireless local area network (WLAN) device connections on any link in the WI-FI subsystem during the threshold time period.

When there is the presence of the new WLAN device connections in the WI-FI subsystem during the threshold time period, the network node may determine the WI-FI subsystem is in the non-idle state.

When there is an absence of the new WLAN device connections in the WI-FI subsystem, then at 430, the network node may calculate a traffic rate such as a data traffic rate (e.g., a receive traffic rate, a transmit traffic rate) for the one or more WI-FI access point devices for the threshold time period. For example, the network node may detect ongoing active network traffic on any link for the one or more WI-FI access point devices for the threshold time period.

In one aspect, the network node may individually calculate the data traffic rate for interfaces associated with all WI-FI access point devices for the threshold time period. In another aspect, the network node may individually calculate the data traffic rate for interfaces associated with at least some WI-FI access point devices for the threshold time period.

The network node may compare the data traffic rate (e.g., for any WI-FI access point device or for each WI-FI access point device) with a threshold traffic rate. A value of the threshold traffic rate may be configurable. The threshold traffic rate may be a receive traffic rate threshold. The threshold traffic rate may be a transmit traffic rate threshold. The threshold traffic rate may be a packet per second threshold.

When the data traffic rate (e.g., for any WI-FI access point device or for each WI-FI access point device) is greater than (or equal to) the threshold traffic rate, the network node may determine the WI-FI subsystem is in the non-idle state.

When the data traffic rate (e.g., for any WI-FI access point device or for each WI-FI access point device) is less than the threshold traffic rate, the network node may determine the WI-FI subsystem is in the idle state. The network node may transition from an active mode into a low power mode, when the WI-FI subsystem is in the idle state.

In certain aspects, a detection algorithm (e.g., executed by the network node) may check whether one or more subsystems of the network node are in the idle state for an idle period. If the one or more subsystems of the network node are in the idle state for the idle period, the network node may enter the low power mode. A value of the idle period may be configurable.

In certain aspects, for the network node to exit the low power mode, the network node may designate a wakeup interface, which may be kept on to receive trigger packets. The trigger packets may be made configurable and are associated with various parameters such as a source internet protocol (IP), a destination IP, a source medium access control (MAC) address, a destination MAC address, a source port and/or a destination port. The network node may exit the low power mode upon receiving the trigger packets.

### Example Method at a Network Node

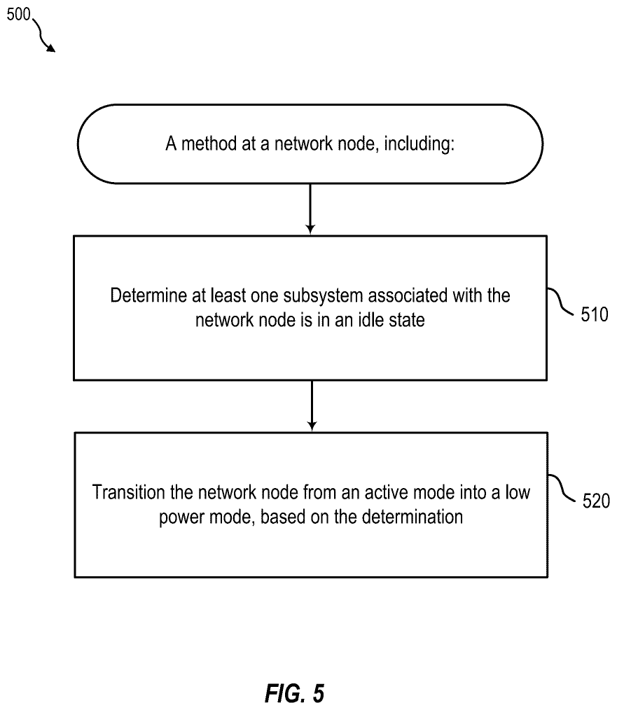

FIG. 5 depicts a method at a network node for managing power modes of the network node. In one example, the network node may be a gateway device. In another example, the network node may be a router device.

At 510, the network node determines at least one subsystem associated with the network node is in an idle state.

At 520, the network node transitions from an active mode into a low power mode, based on the at least one subsystem is in the idle state.

In certain aspects, the network node may transition from the active mode into the low power mode, based on all subsystems associated with the network node being in the idle state.

In certain aspects, the at least one subsystem may be a networking subsystem (NSS). The NSS may include one or more ethernet devices and one or more software programs operating or controlling the one or more ethernet devices.

In certain aspects, the network node calculates a network traffic rate of at least one of the one or more ethernet devices for a threshold time period; determines the network traffic rate is less than a threshold traffic rate; and determines the NSS is in the idle state, based on the network traffic rate is less than the threshold traffic rate.

In certain aspects, the network node calculates an average utilization rate of a central processing unit (CPU) associated with the network node for a threshold time period; determines the average utilization rate is less than a threshold utilization rate; and determines the NSS is in the idle state based on the average utilization rate is less than the threshold utilization rate.

In certain aspects, the network node detect a change in a link state of at least one of the one or more ethernet devices within a threshold time period; and determines the NSS is in the idle state based on the detected change in the link state of the at least one of the one or more ethernet devices within the threshold time period.

In certain aspects, the network node calculates a quantity of connection tracks (CTs) in the NSS; determines the quantity of CTs is less than a threshold number; and determines the NSS is in the idle state based on the quantity of CTs is less than the threshold number.

In certain aspects, the network node calculates a first quantity of CTs for ongoing data traffic flows from one or more connected clients of the network node within a first time period; determines the first quantity of CTs is less than or equal to a second quantity of CTs for data traffic flows from the one or more connected clients within a second time period, wherein the first time period is after the second time period; and determines the NSS is in the idle state based on the first quantity of CTs is less than or equal to the second quantity of CTs.

In certain aspects, the network node calculates a network traffic rate of at least one of the one or more ethernet devices for a first threshold time period; determines the network traffic rate is less than a threshold traffic rate; in response to the network traffic rate is less than the threshold traffic rate, calculates an average utilization rate of a CPU associated with the network node for a second threshold time period; determines the average utilization rate is less than a threshold utilization rate; in response to the average utilization rate is less than the threshold utilization rate, detects whether there is a change in a link state of the at least one of the one or more ethernet devices within a third threshold time period; in response to the change in the link state of the at least one of the one or more ethernet devices within the third threshold time period, calculates a quantity of CTs in the NSS; determines the quantity of CTs is less than a threshold number; in response to the quantity of CTs is less than the threshold number, further calculates a first quantity of CTs for ongoing data traffic flows from one or more connected clients of the network node within a first time period; determines the first quantity of CTs is less than or equal to a second quantity of CTs for data traffic flows from the one or more connected clients within a second time period, wherein the first time period is after the second time period; and determines the NSS is in the idle state based on the first quantity of CTs is less than or equal to the second quantity of CTs.

In certain aspects, the at least one subsystem may be a wireless fidelity (WI-FI) subsystem. The WI-FI subsystem may include one or more WI-FI access point devices and one or more software programs operating or controlling the one or more WI-FI access point devices.

In certain aspects, the network node determines an absence of a new virtual access point (VAP) in the WI-FI subsystem during a threshold time period; and determines the WI-FI subsystem is in the idle state based on the absence of the new VAP in the WI-FI subsystem during the threshold time period.

In certain aspects, the network node determines an absence of a new wireless local area network (WLAN) device connection in the WI-FI subsystem during a threshold time period; and determines the WI-FI subsystem is in the idle state based on the absence of the new WLAN device connection in the WI-FI subsystem during the threshold time period.

In certain aspects, the network node calculates a data traffic rate at an interface associated with at least one of the one or more WI-FI access point devices for a threshold time period; determines the data traffic rate is less than a threshold traffic rate; and determines the WI-FI subsystem is in the idle state based on the data traffic rate is less than the threshold traffic rate.

In certain aspects, the network node determines an absence of a new VAP in the WI-FI subsystem during a threshold time period; in response to the absence of the new VAP in the WI-FI subsystem during the threshold time period, determines whether there is an absence or a presence of a new WLAN device connection in the WI-FI subsystem during the threshold time period; in response to the absence of the new WLAN device connection in the WI-FI subsystem in the threshold time period, calculates a data traffic rate at an interface associated with at least one of the one or more WI-FI access point devices of the WI-FI subsystem for the threshold time period; determines the data traffic rate is less than a threshold traffic rate; and determines the WI-FI subsystem is in the idle state based on the data traffic rate is less than the threshold traffic rate.

### Example Clauses

Implementation examples are described in the following numbered clauses:
Clause 1: A method at a network node, comprising: determining at least one subsystem associated with the network node is in an idle state; and transitioning the network node from an active mode into a low power mode, based on the determination.
Clause 2: The method of clause 1, wherein the network node is a gateway device or a router device.
Clause 3: The method of any one of clauses 1-2, wherein the at least one subsystem is a networking subsystem (NSS), and wherein the NSS comprises one or more ethernet devices and one or more software programs operating or controlling the one or more ethernet devices.
Clause 4: The method of clause 3, further comprising: calculating a network traffic rate of at least one of the one or more ethernet devices for a threshold time period; determining the network traffic rate is less than a threshold traffic rate; and determining the NSS is in the idle state, based on the network traffic rate is less than the threshold traffic rate.
Clause 5: The method of clause 3, further comprising: calculating an average utilization rate of a central processing unit (CPU) associated with the network node for a threshold time period; determining the average utilization rate is less than a threshold utilization rate; and determining the NSS is in the idle state based on the average utilization rate is less than the threshold utilization rate.
Clause 6: The method of clause 3, further comprising: detecting a change in a link state of at least one of the one or more ethernet devices within a threshold time period; and determining the NSS is in the idle state based on the detected change in the link state of the at least one of the one or more ethernet devices within the threshold time period.
Clause 7: The method of clause 3, further comprising: calculating a quantity of connection tracks (CTs) in the NSS; determining the quantity of CTs is less than a threshold number; and determining the NSS is in the idle state based on the quantity of CTs is less than the threshold number.
Clause 8: The method of clause 3, further comprising: calculating a first quantity of connection tracks (CTs) for ongoing data traffic flows from one or more connected clients of the network node within a first time period; determining the first quantity of CTs is less than or equal to a second quantity of CTs for data traffic flows from the one or more connected clients within a second time period, wherein the first time period is after the second time period; and determining the NSS is in the idle state based on the first quantity of CTs is less than or equal to the second quantity of CTs.
Clause 9: The method of clause 3, further comprising: calculating a network traffic rate of at least one of the one or more ethernet devices for a first threshold time period; determining the network traffic rate is less than a threshold traffic rate; in response to the network traffic rate is less than the threshold traffic rate, calculating an average utilization rate of a central processing unit (CPU) associated with the network node for a second threshold time period; determining the average utilization rate is less than a threshold utilization rate; in response to the average utilization rate is less than the threshold utilization rate, detecting whether there is a change in a link state of the at least one of the one or more ethernet devices within a third threshold time period; in response to the change in the link state of the at least one of the one or more ethernet devices within the third threshold time period, calculating a quantity of connection tracks (CTs) in the NSS; determining the quantity of CTs is less than a threshold number; in response to the quantity of CTs is less than the threshold number, further calculating a first quantity of CTs for ongoing data traffic flows from one or more connected clients of the network node within a first time period; determining the first quantity of CTs is less than or equal to a second quantity of CTs for data traffic flows from the one or more connected clients within a second time period, wherein the first time period is after the second time period; and determining the NSS is in the idle state based on the first quantity of CTs is less than or equal to the second quantity of CTs.
Clause 10: The method of any one of clauses 1-9, wherein the at least one subsystem is a wireless fidelity (WI-FI) subsystem, and wherein the WI-FI subsystem comprises one or more WI-FI access point devices and one or more software programs operating or controlling the one or more WI-FI access point devices.
Clause 11: The method of clause 10, further comprising: determining an absence of a new virtual access point (VAP) in the WI-FI subsystem during a threshold time period; and determining the WI-FI subsystem is in the idle state based on the absence of the new VAP in the WI-FI subsystem during the threshold time period.
Clause 12: The method of clause 10, further comprising: determining an absence of a new wireless local area network (WLAN) device connection in the WI-FI subsystem during a threshold time period; and determining the WI-FI subsystem is in the idle state based on the absence of the new WLAN device connection in the WI-FI subsystem during the threshold time period.
Clause 13: The method of clause 10, further comprising: calculating a data traffic rate at an interface associated with at least one of the one or more WI-FI access point devices for a threshold time period; determining the data traffic rate is less than a threshold traffic rate; and determining the WI-FI subsystem is in the idle state based on the data traffic rate is less than the threshold traffic rate.
Clause 14: The method of clause 10, further comprising: determining an absence of a new virtual access point (VAP) in the WI-FI subsystem during a threshold time period; in response to the absence of the new VAP in the WI-FI subsystem during the threshold time period, determining whether there is an absence or a presence of a new wireless local area network (WLAN) device connection in the WI-FI subsystem during the threshold time period; in response to the absence of the new WLAN device connection in the WI-FI subsystem in the threshold time period, calculating a data traffic rate at an interface associated with at least one of the one or more WI-FI access point devices of the WI-FI subsystem for the threshold time period; determining the data traffic rate is less than a threshold traffic rate; and determining the WI-FI subsystem is in the idle state based on the data traffic rate is less than the threshold traffic rate.
Clause 15: An apparatus, comprising: at least one memory comprising instructions; and one or more processors configured, individually or in any combination, to execute the instructions and cause the apparatus to perform a method in accordance with any one of Clauses 1-14.
Clause 16: An apparatus, comprising means for performing a method in accordance with any one of Clauses 1-14.
Clause 17: A non-transitory computer-readable medium comprising executable instructions that, when executed by one or more processors of an apparatus, cause the apparatus to perform a method in accordance with any one of Clauses 1-14.
Clause 18: A computer program product embodied on a computer-readable storage medium comprising code for performing a method in accordance with any one of Clauses 1-14.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more. ” Unless specifically stated otherwise, the term “some” refers to one or more. No claim element is to be construed under the provisions of 35 U.S. C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus at a network node, comprising:
a memory comprising instructions; and
one or more processors, individually or collectively, configured to execute the instructions and cause the apparatus to:
determine at least one subsystem associated with the network node is in an idle state; and
transition the network node from an active mode into a low power mode, based on the determination.

2. The apparatus of claim 1, wherein the network node is a gateway device or a router device.

3. The apparatus of claim 1, wherein the at least one subsystem is a networking subsystem (NSS), and wherein the NSS comprises one or more ethernet devices and one or more software programs operating or controlling the one or more ethernet devices.

4. The apparatus of claim 3, wherein the one or more processors, individually or collectively, are configured to execute the instructions and cause the apparatus to:
calculate a network traffic rate of at least one of the one or more ethernet devices for a threshold time period;
determine the network traffic rate is less than a threshold traffic rate; and
determine the NSS is in the idle state, based on the network traffic rate is less than the threshold traffic rate.

5. The apparatus of claim 3, wherein the one or more processors, individually or collectively, are configured to execute the instructions and cause the apparatus to:
calculate an average utilization rate of a central processing unit (CPU) associated with the network node for a threshold time period;
determine the average utilization rate is less than a threshold utilization rate; and
determine the NSS is in the idle state based on the average utilization rate is less than the threshold utilization rate.

6. The apparatus of claim 3, wherein the one or more processors, individually or collectively, are configured to execute the instructions and cause the apparatus to:
detect a change in a link state of at least one of the one or more ethernet devices within a threshold time period; and
determine the NSS is in the idle state based on the detected change in the link state of the at least one of the one or more ethernet devices within the threshold time period.

7. The apparatus of claim 3, wherein the one or more processors, individually or collectively, are configured to execute the instructions and cause the apparatus to:
calculate a quantity of connection tracks (CTs) in the NSS;
determine the quantity of CTs is less than a threshold number; and
determine the NSS is in the idle state based on the quantity of CTs is less than the threshold number.

8. The apparatus of claim 3, wherein the one or more processors, individually or collectively, are configured to execute the instructions and cause the apparatus to:
calculate a first quantity of connection tracks (CTs) for ongoing data traffic flows from one or more connected clients of the network node within a first time period;
determine the first quantity of CTs is less than or equal to a second quantity of CTs for data traffic flows from the one or more connected clients within a second time period, wherein the first time period is after the second time period; and
determine the NSS is in the idle state based on the first quantity of CTs is less than or equal to the second quantity of CTs.

9. The apparatus of claim 3, wherein the one or more processors, individually or collectively, are configured to execute the instructions and cause the apparatus to:
calculate a network traffic rate of at least one of the one or more ethernet devices for a first threshold time period;
determine the network traffic rate is less than a threshold traffic rate;
in response to the network traffic rate is less than the threshold traffic rate, calculate an average utilization rate of a central processing unit (CPU) associated with the network node for a second threshold time period;
determine the average utilization rate is less than a threshold utilization rate;
in response to the average utilization rate is less than the threshold utilization rate, detect whether there is a change in a link state of the at least one of the one or more ethernet devices within a third threshold time period;
in response to the change in the link state of the at least one of the one or more ethernet devices within the third threshold time period, calculate a quantity of connection tracks (CTs) in the NSS;
determine the quantity of CTs is less than a threshold number;
in response to the quantity of CTs is less than the threshold number, calculate a first quantity of CTs for ongoing data traffic flows from one or more connected clients of the network node within a first time period;
determine the first quantity of CTs is less than or equal to a second quantity of CTs for data traffic flows from the one or more connected clients within a second time period, wherein the first time period is after the second time period; and
determine the NSS is in the idle state based on the first quantity of CTs is less than or equal to the second quantity of CTs.

10. The apparatus of claim 1, wherein the at least one subsystem is a wireless fidelity (WI-FI) subsystem, and wherein the WI-FI subsystem comprises one or more WI-FI access point devices and one or more software programs operating or controlling the one or more WI-FI access point devices.

11. The apparatus of claim 10, wherein the one or more processors, individually or collectively, are configured to execute the instructions and cause the apparatus to:
determine an absence of a new virtual access point (VAP) in the WI-FI subsystem during a threshold time period; and
determine the WI-FI subsystem is in the idle state based on the absence of the new VAP in the WI-FI subsystem during the threshold time period.

12. The apparatus of claim 10, wherein the one or more processors, individually or collectively, are configured to execute the instructions and cause the apparatus to:
determine an absence of a new wireless local area network (WLAN) device connection in the WI-FI subsystem during a threshold time period; and
determine the WI-FI subsystem is in the idle state based on the absence of the new WLAN device connection in the WI-FI subsystem during the threshold time period.

13. The apparatus of claim 10, wherein the one or more processors, individually or collectively, are configured to execute the instructions and cause the apparatus to:
calculate a data traffic rate at an interface associated with at least one of the one or more WI-FI access point devices for a threshold time period;
determine the data traffic rate is less than a threshold traffic rate; and
determine the WI-FI subsystem is in the idle state based on the data traffic rate is less than the threshold traffic rate.

14. The apparatus of claim 10, wherein the one or more processors, individually or collectively, are configured to execute the instructions and cause the apparatus to:
determine an absence of a new virtual access point (VAP) in the WI-FI subsystem during a threshold time period;
in response to the absence of the new VAP in the WI-FI subsystem during the threshold time period, determine whether there is an absence or a presence of a new wireless local area network (WLAN) device connection in the WI-FI subsystem during the threshold time period;
in response to the absence of the new WLAN device connection in the WI-FI subsystem in the threshold time period, calculate a data traffic rate at an interface associated with at least one of the one or more WI-FI access point devices of the WI-FI subsystem for the threshold time period;
determine the data traffic rate is less than a threshold traffic rate; and
determine the WI-FI subsystem is in the idle state based on the data traffic rate is less than the threshold traffic rate.

15. A method at a network node, comprising:
determining at least one subsystem associated with the network node is in an idle state; and
transitioning the network node from an active mode into a low power mode, based on the determination.

16. The method of claim 15, wherein the at least one subsystem is a networking subsystem (NSS), and wherein the NSS comprises one or more ethernet devices and one or more software programs operating or controlling the one or more ethernet devices.

17. The method of claim 16, further comprising:
calculating a network traffic rate of at least one of the one or more ethernet devices for a first threshold time period;
determining the network traffic rate is less than a threshold traffic rate;
in response to the network traffic rate is less than the threshold traffic rate, calculating an average utilization rate of a central processing unit (CPU) associated with the network node for a second threshold time period;
determining the average utilization rate is less than a threshold utilization rate;
in response to the average utilization rate is less than the threshold utilization rate, detecting whether there is a change in a link state of the at least one of the one or more ethernet devices within a third threshold time period;
in response to the change in the link state of the at least one of the one or more ethernet devices within the third threshold time period, calculating a quantity of connection tracks (CTs) in the NSS;
determining the quantity of CTs is less than a threshold number;
in response to the quantity of CTs is less than the threshold number, further calculating a first quantity of CTs for ongoing data traffic flows from one or more connected clients of the network node within a first time period;
determining the first quantity of CTs is less than or equal to a second quantity of CTs for data traffic flows from the one or more connected clients within a second time period, wherein the first time period is after the second time period; and
determining the NSS is in the idle state based on the first quantity of CTs is less than or equal to the second quantity of CTs.

18. The method of claim 15, wherein the at least one subsystem is a wireless fidelity (WI-FI) subsystem, and wherein the WI-FI subsystem comprises one or more WI-FI access point devices and one or more software programs operating or controlling the one or more WI-FI access point devices.

19. The method of claim 18, further comprising:
determining an absence of a new virtual access point (VAP) in the WI-FI subsystem during a threshold time period;
in response to the absence of the new VAP in the WI-FI subsystem during the threshold time period, determining whether there is an absence or a presence of a new wireless local area network (WLAN) device connection in the WI-FI subsystem during the threshold time period;
in response to the absence of the new WLAN device connection in the WI-FI subsystem in the threshold time period, calculating a data traffic rate at an interface associated with at least one of the one or more WI-FI access point devices of the WI-FI subsystem for the threshold time period;
determining the data traffic rate is less than a threshold traffic rate; and
determining the WI-FI subsystem is in the idle state based on the data traffic rate is less than the threshold traffic rate.

20. An apparatus at a network node, comprising:
means for determining at least one subsystem associated with the network node is in an idle state; and
means for transitioning the network node from an active mode into a low power mode, based on the determination.
